(19) United States
(12) Patent Application Publication
(10) Pub. No.: US 2003/0007045 A1
(43) Pub. Date: Jan. 9, 2003

(54) Ink container, inkjet printing apparatus, and ink supplying method

(76) Inventors: Masahito Yoshida, Saitama (JP); Naoji Otsuka, Kanagawa (JP); Hiroyuki Inoue, Kanagawa (JP); Takashi Nojima, Tokyo (JP); Hitoshi Sugimoto, Kanagawa (JP); Shusuke Inamura, Tokyo (JP); Yasufumi Tanaami, Tokyo (JP); Takeshi Iwasaki, Kanagawa (JP); Noriko Sato, Kanagawa (JP); Yasuyuki Hirai, Kanagawa (JP); Takeshi Yazawa, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/171,629

(22) Filed: Jun. 17, 2002

(30) Foreign Application Priority Data
Jun. 18, 2001 (JP) 183742/2001(PAT.)

(51) Int. Cl. B41J 2/175

(52) U.S. Cl. 347/86

(57) ABSTRACT

A structure which includes a container for reserving a predetermined amount of ink to be supplied to a printing head and in which a supply system is configured such that ink is intermittently supplied to the container from an ink tank as an ink supply source makes it possible to reduce the time for charging the container with ink. A member for holding ink and generating a negative pressure originating from an elastic force is provided in the container. With connecting the tank and the member, the pressure in the container is reduced to cause the member to expand, thereby introducing ink into the same. This introduction is stopped by regulating the expansion with a displaceable unit. A negative pressure is generated in the member by canceling regulation by the unit to put it in equilibrium with an ink meniscus holding ability of the printing head.

This application is based on Patent Application Ser. No. 2001-183742 filed Jun. 18, 2001 in Japan, the content of which is incorporated hereinto by reference.

### BACKGROUND OF THE INVENTION

1. Field of the Invention

The present invention relates to an ink container, an inkjet printing apparatus utilizing the ink container, and an ink supplying method and, more particularly, the invention is preferably applied to an inkjet printing apparatus in which ink is intermittently supplied to a printing head for ejecting ink.

2. Description of the Related Art

Inkjet printing apparatuses which form an image on a printing medium by depositing ink to the printing medium using an inkjet printing head include that which form an image by ejecting ink while moving a printing head relative to a printing medium and that which form an image by ejecting ink while moving a printing medium relative to a fixed printing head conversely.

There are two general types of methods of supplying ink to a printing head used in such an inkjet printing apparatus. One is a type in which a supply system is configured such that an amount of ink is always or continuously supplied to a printing head according to the amount of ink ejected (hereinafter referred to as a continuous supply type), and the other is a type in which a printing head is provided with a reservoir (sub-tank or second ink tank) for reserving a predetermined amount of ink and in which a supply system is configured such that ink is supplied to the reservoir from an ink supply source (main tank or first ink tank) at appropriate timing or intermittently (hereinafter referred to as an intermittent supply type).

The continuous supply type is further categorized into two types, for example, when it is used in an inkjet printing apparatus of a type referred to as a serial type in which a printing head is scanned back and forth in predetermined directions relative to a printing medium and in which the printing medium is transported in a direction substantially orthogonal thereto to form an image. One is a type referred to as an on-carriage type in which ink is supplied by integrally or detachably attaching an ink tank to a printing head that is carried and moved back and forth (main scanning) by a carriage. The other is a tube supply type in which an ink tank that is separate from a printing head carried on a carriage is fixedly installed in a part of a printing apparatus other than the printing head and in which the ink tank is connected to the printing head through a flexible tube to supply ink. In some of the latter type, a second ink tank that serves as an intermediate tank between an ink tank and a printing head is mounted on the printing head or the carriage.

When an on-carriage type structure is adopted, there are limits on the project area in a direction perpendicular to the main scanning direction and volume of members that move with a carriage (a printing head and an ink tank undetachably or detachably integrated with the same). Therefore, only an ink tank having a very limited capacity can be used when a small-sized printing apparatus, especially, a portable printing apparatus is to be formed. This results in very frequent replacement of the printing head integral with the ink tank or the ink tank alone, which has been problematic from the viewpoint of operability and running cost. Further, the recent spread of so-called mobile apparatus is remarkable and, for example, ultra-compact inkjet printers have been proposed which can be integrated with notebook type personal computers and digital cameras. It is considered impractical to design such printers in adaptation to the on-carriage method.

When a tube supply type structure is adopted, although members that move with a carriage during main scanning can be made compact to some degree, it is difficult to make the apparatus as a whole compact because a space is required for a tube member to move to follow up the carriage, the tube member coupling a printing head on the carriage and an ink tank located outside the carriage to supply ink. Further, the recent trend is that a carriage is scanned at a high speed to accommodate increases in the speed of printing operations, and resultant severe rocking of a tube that follows the carriage results in changes in the pressure of ink in an ink supply system for the printing head. It is therefore required to provide various complicated pressure buffering mechanisms in order to suppress pressure changes, it has been difficult to achieve a size reduction in this respect too

On the contrary, in the case of the intermittent supply method that is used for serial type inkjet printing apparatus for example, a relatively small second ink tank and printing head are provided on a carriage; a relatively large first ink tank is provided in a part other than the carriage of the printing apparatus; and a supply system is configured such that ink is supplied from the first ink tank to the second ink tank at appropriate timing. A structure is also employed in which the ink supply system between the first and second ink tanks is spatially separated or the ink channel is blocked with a valve during main scanning to achieve fluid isolation between the first and second ink tanks. Basically, this makes it possible to solve various problems attributable to the size of moving members as described above such as an ink tank and the rocking of a tube that have limited efforts to achieve a small size in the case of the continuous supply type.

When an intermittent supply type structure is adopted, however, it is important to adjust the pressure inside a second ink tank properly, because a negative pressure relative to the atmosphere must be generated in order to maintain ink meniscuses formed at ejection openings. While the second ink tank maybe located in a position lower than the position of ejection openings of the printing head to generate a negative pressure in the second ink tank naturally, this puts a limit on even the position and attitude or orientation of the ink tank and has resulted in problems including leakage of ink from the ejection openings especially in case that a portable printing apparatus is to be provided which is unstable in attitude or orientation during transportation.

Under such circumstances, proposals have been made is including a proposal in which a porous member such as a sponge for holding ink is contained a second ink tank to generate an adequate negative pressure. Such a structure is advantageous even for a portable printing apparatus whose attitude is unstable during transportation. However, the ink containing efficiency of the second ink tank is limited by the negative pressure generating mechanism such as a porous member provided in the second ink tank. Further, designing may be limited with respect to the endurance of the porous member against deposition and deterioration of a dye or pigment in ink, which also reduces freedom in selecting ink.

Further, in such a structure, since the porous member is always over-charged with ink when ink charging is completed, the over-charged ink in the porous member must be discharged as waste ink without fail by performing an operation of sucking the printing head through the ejection openings after the charging is completed in order to apply a required negative pressure to the printing head. That is, a problem arises in that a charging operation is accompanied by the generation of waste ink.

### SUMMERY OF THE INVENTION

The invention was made taking the above problems into consideration, and it provides a structure in which an intermittent supply system is adopted as an ink supply system; waste of ink such as generation of waste ink associated with a charging operation will not fundamentally occur; high charging efficiency and a short charging time is achieved; and endurance of ink can be easily maintained, i.e., a structure with which freedom in selecting ink can be increased.

The invention thus contributes to the structure of a compact and portable inkjet printing apparatus.

In a first aspect of the present invention, there is provided an ink container that can be disposed halfway of an ink supply path connecting a printing head for performing printing by ejecting ink and an ink tank serving as a supply source of ink to be supplied to the printing head, comprising:

an ink containing body capable of containing ink introduced thereto from the ink tank in a state in which it is in fluid communication with the ink tank, the ink containing body supplying the ink contained therein to the printing head during printing and having a part that can be displaced in the direction of increasing an internal volume thereof to introduce the ink;

a housing having an inner space in which a pressure can be adjusted, the housing allowing the ink containing body to be contained in the space and allowing an increase in the internal volume thereof in accordance with the pressure adjustment; and

regulating means provided in the housing such that it can regulate the displacement of the part of the ink containing body in the direction of increasing the internal volume to a predetermined position.

In a second aspect of the present invention, the regulating means has a regulating member which can expand according to depressurization of the inner space of the housing and which abuts on the part of the ink containing body as a result of the expansion to regulate the displacement of the same.

In a third aspect of the present invention, the regulating means has a regulating member that can be displaced to a position in which it abuts on the part of the ink containing body to regulate the displacement of the same.

In a fourth aspect of the present invention, there is provided an inkjet printing apparatus for performing printing by using a printing head for ejecting ink, an ink tank serving as a source of ink to be supplied to the printing head, and an ink container provided halfway of an ink supply path connecting the printing head and the ink tank according to the above second aspect, the apparatus comprising:

channel opening and closing means for establishing and blocking fluid communication between the ink tank and the ink containing body; and

pressure adjusting means for reducing the pressure in the inner space of the housing in the communicated state is to increase the internal volume of the ink containing body and to expand the regulating member and for canceling the depressurized state after the regulation Is performed.

In a fifth aspect of the present invention, there is provided an inkjet printing apparatus for performing printing by using a printing head for ejecting ink, an ink tank serving as a source of ink to be supplied to the printing head, and an ink container provided halfway of an ink supply path connecting the printing head and the ink tank according to the above third aspect, the apparatus comprising:

channel opening and closing means for establishing and blocking fluid communication between the ink tank and the ink containing body;

pressure adjusting means for reducing the pressure in the inner space of the housing in the communicated state to increase the internal volume of the ink containing body; and

control means for displacing the regulating member towards the regulating position and for displacing the regulating member from the regulating position after the regulation is performed.

In a sixth aspect of the present invention, there is provided an ink supplying method used for an inkjet printing apparatus for performing printing by using a printing head for ejecting ink, an ink tank serving as a source of ink to be supplied to the printing head, and an ink container provided halfway of an ink supply path connecting the printing head and the ink tank according to the above second aspect, the method for supplying the ink to the ink container from the ink tank, the method comprising the steps of:

establishing fluid communication between the ink tank and the ink containing body;

reducing the pressure in the inner space of the housing in the communicated state to increase the internal volume of the ink containing body and to expand the regulating member; and

canceling the depressurized state after the regulation is performed.

In a seventh aspect of the present invention, there is provided an ink supplying method used for an inkjet printing apparatus for performing printing by using a printing head for ejecting ink, an ink tank serving as a source of ink to be supplied to the printing head, and an ink container provided halfway of an ink supply path connecting the printing head and the ink tank according to the above third aspect, the method for supplying the ink to the ink container from the ink tank, the method comprising the steps of:

establishing fluid communication between the ink tank and the ink containing body;

reducing the pressure in the inner space of the housing in the communicated state to increase the internal volume of the ink containing body; and

controlling to displace the regulating member towards the regulating position and to displace the regulating member from the regulating position after the regulation is performed.

In an eighth aspect of the present invention, there is provided an ink supplying method for supplying ink to an ink container accommodating an ink containing body capable of containing the ink therein and capable of generating a negative pressure by an elastic force from an ink tank serving the ink to be supplied to a printing head, the method comprising the steps of:

establishing fluid communication between the ink tank and the ink containing body;

depressurizing the interior of the ink container to expand the ink containing body, thereby introducing the ink to the ink containing body from the ink tank; and

regulating the expansion of the ink containing body by using displaceable regulating means, thereby stopping the introduction of the ink.

In a ninth aspect of the present invention, there is provided an ink supplying method for supplying ink to an ink container accommodating an ink containing body capable of containing the ink therein and capable of changing an internal volume thereof with a flexible structure from an ink tank serving the ink to be supplied to a printing head, the method comprising the steps of;

establishing fluid communication between the ink tank and the ink containing body;

increasing the internal volume of the ink containing body, thereby introducing the ink to the ink containing body from the ink tank; and

regulating the increase of the internal volume of the ink containing body by using displaceable regulating means, thereby stopping the introduction of the ink.

Incidentally, in the present specification, the wording “printing” means not only a condition of forming significant information such as characters and drawings, but also a condition of forming images, designs, patterns and the like on printing medium widely or a condition of processing the printing media, regardless of significance or unmeaning or of being actualized in such manner that a man can be perceptive through visual perception.

Further, the wording “printing medium” means not only a paper used in a conventional printing apparatus but also everything capable of accepting inks, such as fabrics, plastic films, metal plates, glasses, ceramics, wood and leathers, and in the following, will be also represented by a “sheet” or simply by “paper”.

Still further, the wording “ink” (also referred to as “liquid” in some occasions) should be interpreted in a broad sense as well as a definition of the above “printing” and thus the ink, by being applied on the printing media, shall mean a liquid to be used for forming images, designs, patterns and the like, processing the printing medium or processing inks (for example, coagulation or encapsulation of coloring materials in the inks to be applied to the printing media).

Meantime, the present invention may be applied to a printing head in which a thermal energy generated by an electrothermal transducer is utilized to cause a film boiling to liquid in order to form bubbles, a printing head in which an electromechanical transducer is employed to eject liquid, a printing head in which a static electricity or air current is utilized to form and eject a liquid droplet and the others which are proposed in the art of an inkjet printing technology. Specifically, the printing head in which the electrothermal transducer is utilized is advantageously employed to achieve a compact structure.

Still further the wording “nozzle”, as far as not mentioned specifically represents to an ejection opening, a liquid passage communicated with the opening and an element for generating an energy used for ink, in summary.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a schematic plan view showing a general structure of an inkjet printing apparatus utilizing an intermittent supply system according to an embodiment of the invention;

FIG. 2 is a schematic plan view showing a general structure of an inkjet printing apparatus employing an intermittent supply system utilizing a normally connected tube mechanism unlike the structure in FIG. 1;

FIG. 3 is a block diagram showing an example of a schematic structure of a control system in the inkjet printing apparatus in FIG. 1 or FIG. 2;

FIG. 4 is a schematic side view for explaining a first example of an internal structure of a printing head unit used for the intermittent supply system in the structure in FIG. 1 and connection circuits coupled with and located around the same;

FIGS. 5A, 5B, and 5C are illustrations for explaining an example of a structure and operation of valve units for supplying ink that can be used in the structure in FIG. 4;

FIG. 6 is a flow chart showing an example of a processing procedure for charging ink from a first ink tank to a second ink tank in the structure in FIG. 1;

FIG. 7 is an illustration for explaining conditions such as dimensions and specifications of each part of the intermittent supply system to be satisfied to ensure that the expansion of the second ink tank in FIG. 4 will be stopped;

FIG. 8 is an illustration for explaining conditions such as dimensions and specifications of each part of the intermittent supply system to be satisfied to ensure that the expansion of the second ink tank in FIG. 4 will be stopped;

FIGS. 9A and 9B are schematic diagrams showing comparative examples of preferable structures of the intermittent supply system for reliably regulating the expansion of the second ink tank;

FIG. 10 is a schematic diagram showing an example of a structure utilizing an air pressure type expansion regulating member for reliably regulating the expansion of the second ink tank;

FIGS. 11A and 11B are schematic diagrams showing two examples of other structures each utilizing an air pressure type expansion regulating member;

FIGS. 12A and 12B are schematic diagrams showing two examples of structures each utilizing an air pressure type expansion regulating member for reliably regulating the expansion of a plurality of second ink tanks;

FIGS. 13A, 13B, and 13C are schematic diagrams showing other three examples of an expansion regulating member for reliably regulating the expansion of the second ink tank; and

FIG. 14 is a flow chart showing an example of a processing procedure for ink charging in the structures in FIGS. 13A, 13B, and 13C.

### DETAILED DESCRIPTION OF THE PREFERRED EMBODIMENTS

The invention will now be described in detail with reference to the drawings.

(Example of Structure of Inkjet Printing Apparatus)

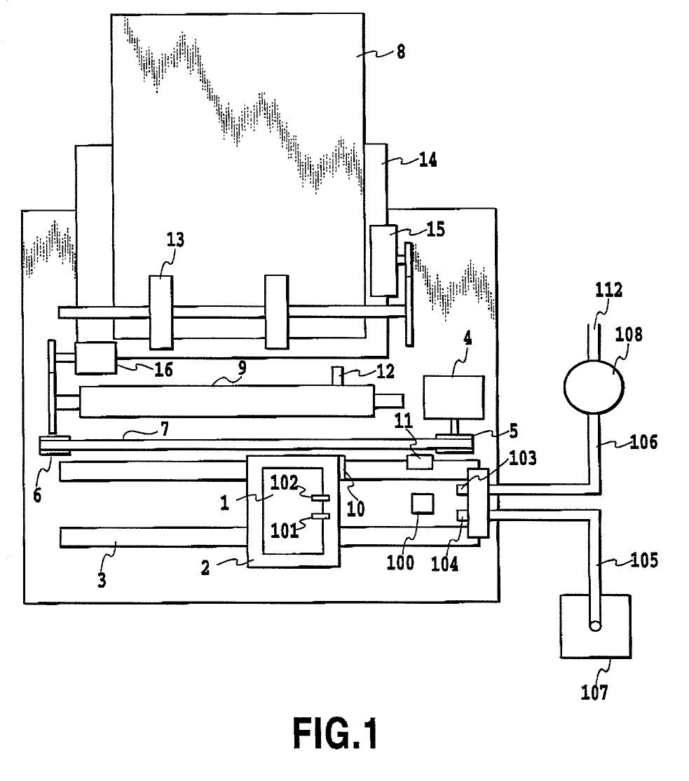

FIG. 1 is a schematic plan view showing a general structure of an inkjet printing apparatus utilizing an intermittent supply system according to an embodiment of the invention.

In the structure in FIG. 1, a printing head unit 1 is replaceably mounted on a carriage 1. The printing head unit 1 has a printing head section and a second ink tank section, and there is provided a connector (not shown) for transmitting signals such as a drive signal for driving the head section to cause an ink ejecting operation of a nozzle. The carriage 2 on which the printing head unit 1 is positioned and replaceably mounted is provided with a connector holder (electrical connecting section) for transmitting signals such as the drive signal to the printing head unit 1 through the connector.

The carriage 2 is guided and supported by a guide shaft 3 provided on a main body of the apparatus and is extending in a main scanning direction such that it can be moved back and forth along the guide shaft. The carriage 2 is driven and controlled with respect to its position and movement by a main scanning motor 4 through transmission mechanisms such as a motor pulley 5, a driven pulley 6, and a timing belt 7. For example, a home position sensor 10 in the form of a transmission type photo interrupter interrupter is provided, and a blocking plate 11 is disposed in a fixed part of the apparatus associated with a home position of the carriage such that it can block an optical axis of the transmission type photo-interrupter. Thus, when the home position sensor 10 passes through the blocking plate 11 as a result of the movement of the carriage 2, the home position is detected, and the position and movement of the carriage can be controlled using the detected position as a reference.

Printing media 8 that are printing paper or plastic sheets are separately fed one by one from an automatic sheet feeder (hereinafter referred to as an ASF) by rotating a pick-up roller 13 with an ASF motor 15 through a gear. Further, the medium is transported through a position (printing section) in a face-to-face relationship with a surface of the printing head unit 1 where ejection openings are formed as a result of the rotation of a transport roller 9 (sub scanning). The transport roller 9 is driven by transmitting the rotation of a line feed (LF) motor 16 through a gear.

At this time, judgment on whether the paper has been fed and decision of a print starting position on the printing medium in a sub scanning direction is performed based on output of a paper end sensor 12 for detecting the presence of a printing medium disposed upstream of a printing position on a printing medium transport path. The paper end sensor 12 is used to detect a rear end of a printing medium 8 and to decide a final printing position on the printing medium in the sub scanning direction based on the detection output.

The printing medium 8 is supported by a platen (not shown) at a bottom surface thereof such that a flat surface is formed In a portion thereof to be printed. In doing so, the printing head unit 1 carried by the carriage 2 is held such that the surface thereof where the ejection openings are formed protrudes downward from the carriage in parallel with the printing medium 8. For example, the printing head unit 1 is an inkjet printing head unit having a structure for ejecting ink utilizing thermal energy and having an electrothermal transducer for generating thermal energy that causes film boiling of ink. That is, the printing head of the printing head unit 1 performs printing by utilizing the pressure of bubbles generated as a result of film boiling of ink caused by the thermal energy applied by the electrothermal transducer to eject ink. Obviously, a different type of unit such as a unit that ejects ink utilizing a piezoelectric device may be used.

Reference numeral 100 represents a recovery system mechanism that has a cap member used for an operation of recovering suction of ink from the printing head unit 1 and for protecting the surface of the printing head where the ejection openings are formed. The cap member can be set in positions where it is joined to and detached from the surface where the ejection openings are formed by a motor that is not shown operations such as the suction recovery operation of the printing head are performed by generating a negative pressure in the cap member by a suction pump which is not shown in the joined state. The surface of the printing head where the ejection openings are formed can be protected by keeping the cap member in the joined state when the printing apparatus is not used.

Reference numeral 101 represents a valve unit provided on the printing head unit side for coupling the printing head unit 1 to an ink supply source. Reference numeral 104 represents a valve unit provided at the ink supply source side to be paired with the valve unit 101. Reference numeral 102 represents a valve unit provided on the printing head unit side for coupling the printing head unit 1 to an air pump units Reference numeral 103 represents a valve unit provided on an air pump unit side to be paired with the valve unit 102.

The valve units 101 through 104 are in contact and coupled with the respective valve units to allow ink and air to flow between the valve units when the carriage 2 is located at the home position outside a printing area in the main scanning direction or at a position in the vicinity of the same. The valve units are decoupled from each other when the carriage 2 moves away the position toward the printing area, and the valve units 101 and 104 automatically enter a closed state as a result of the decoupling. On the contrary, the valve unit 102 is always in an open state.

Reference numeral 105 represents a tube member that is coupled with a first ink tank 107 to supply ink to the valve unit 104. Reference numeral 106 represents a tube member for an air pressure or pneumatic circuit, the tube member being coupled with a pump unit 108 for pressurization and depressurization. Reference numeral 112 represents a suction and exhaust port of the pump unit 108. It is not essential to configure each of the tube members as an integral unit, and it may be configured by combining a plurality of tube elements.

(Another Example of Structure of Inkjet Printing Apparatus)

The intermittent supply system in FIG. 1 has a structure in which the valve units are coupled only when the second ink tank is charged with ink and in which the ink supply system between the first and second ink tanks is spatially disconnected during a printing operation. An intermittent supply system may be employed in which the ink channel or a fluid path is blocked with a valve instead of such disconnection to achieve fluid isolation between the first and second ink tanks.

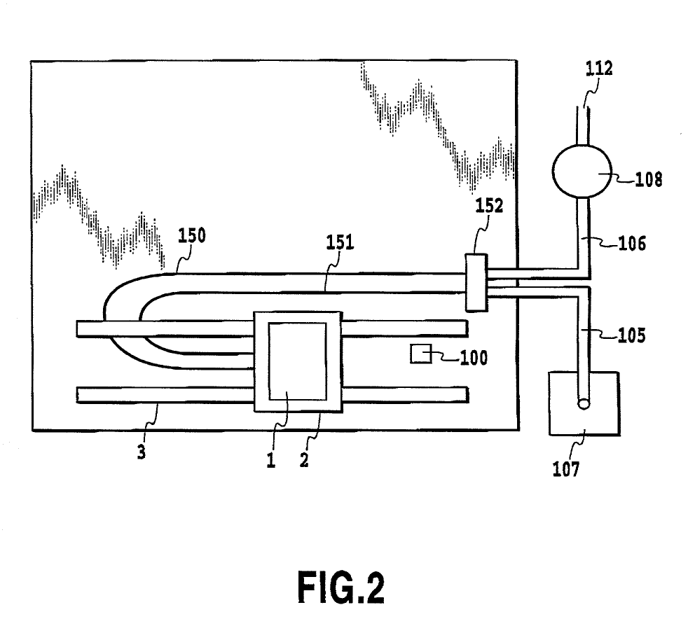

FIG. 2 schematically shows an inkjet printing apparatus in which an intermittent supply system utilizing a normally connected tube mechanism is used. For simplicity, FIG. 2 does not show parts which can be configured similarly to those in FIG. 1 and which are not related to the description of the supply system of the present example.

In FIG. 2, reference numeral 150 represents a flexible tube for an air pressure circuit that is connected to a second ink tank of a printing head unit at one end thereof and connected to a pump unit 108 for pressurization and depressurization through an electromagnetic valve unit 152 and a tube member 106 for the air pressure circuit at another end thereof. Reference numeral 151 represents a flexible tube for supplying ink that is connected to the second ink tank of the printing head unit at one end thereof and connected to first ink tank 107 through the electromagnetic valve unit 152 and a tube member 105 for supplying Ink at another end thereof

That is, an intermittent supply system may be configured even using such a normally connected tube mechanism by interposing units for opening to form and closing to block a channel such as the electromagnetic valve unit 152 and by controlling the opening and closing of the same appropriately during an operation of charging the second ink tank with ink and a printing operation.

(Example of Structure of Control System)

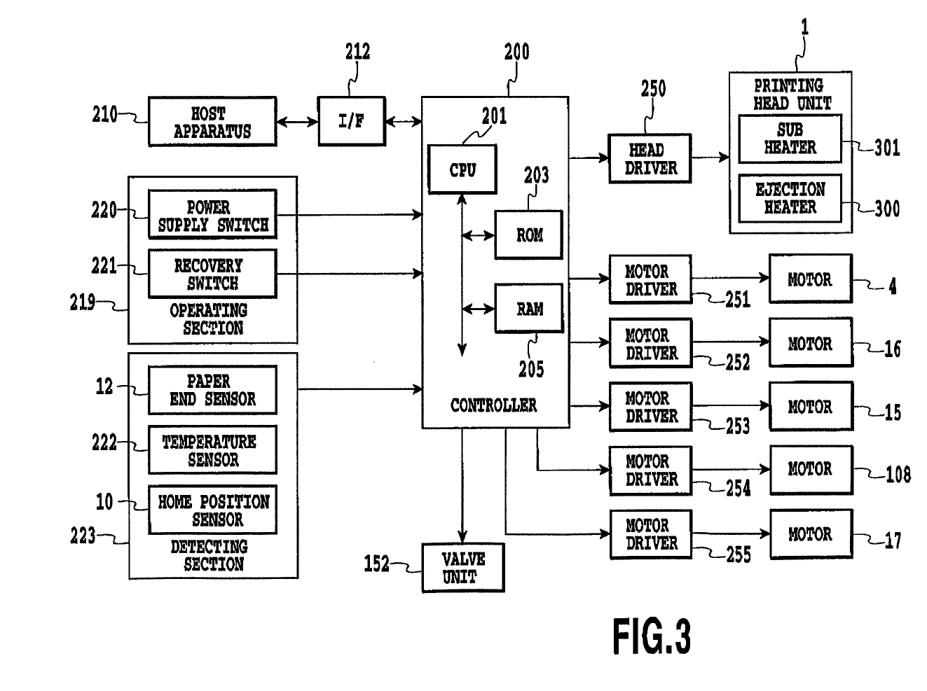

FIG. 3 is a block diagram showing an example of a schematic structure of a control system in the inkjet printing apparatus in FIG. 1 or FIG. 2.

In FIG. 3, a controller 200 serves as a main control section and has a CPU 201 in the form of a microcomputer, a ROM 203 in which fixed data such as programs and required tables are stored, and a RAM 205 having areas such as an area for arranging image data and a work area, for example. A host apparatus 210 is a supply source of image data which may be a computer for generating and processing data such as image to be printed and may alternatively be a reader for reading images or a digital camera. An inkjet printing apparatus according to the present embodiment or the invention may be configured separately from such a host apparatus 210 or may be configured integrally with the same in a separable or inseparable manner.

Image data, commands, and status signals are transmitted and received to and from the controller 200 through an interface 212. An operating section 219 has a power supply switch 220 and switches for accepting input of instructions of an operator such as recovery switch 221 for instructing activation of suction recovery. A detecting section 223 has sensors for detecting states of the apparatus such as the home position sensor 10 described above, a paper end sensor 12 for detecting the presence of a printing medium, and a temperature sensor 222 provided in an appropriate part for detecting the ambient temperature.

A head driver 250 is a driver for driving an electrothermal transducer (ejection heater) 300 of the printing head 1 according to printing data. The head driver 250 has a shift register for arranging printing data in association with the position of the ejection heater 300, a latch circuit for latching the arranged printing data at appropriate timing, a logic circuit element for actuating the ejection heater in synchronism with a drive timing signal, and a timing setting section for appropriately setting ejection heater drive timing (ejection timing) to perform registration of dot forming positions (a registration process) as needed. The printing head 1 is also provided with a sub-heater 301 for performing temperature adjustment in order to stabilize ink ejection characteristics. The sub-heater 301 may have a structure in which it is formed on a substrate of the printing head concurrently with the ejection heater 300 and/or a structure in which it is mounted to the printing head main body or printing head unit.

Reference numeral 251 represents a motor driver for driving the main scanning motor 4; reference numeral 252 represents a motor driver for driving the line feed (LF) motor 16; and reference numeral 253 represents a motor driver for driving the ASP motor 15. Reference numeral 254 represents a driver for driving and controlling the pump unit 108, and reference numeral 255 represents a motor driver for driving a motor 17 for operating the recovery system.

Reference numeral 38 represents a driver for driving a valve unit for opening and closing the channel. While it is not required when the valve units 101 and 104 are used which are coupled with and separated from each other to cause the channel to open and close automatically as in the example of structure in FIG. 1, it is used in a structure in which the channel is passively opened and closed, i.e., when the electromagnetic valve 152 for opening and closing the ink channel is disposed as in the example of structure in FIG. 2.

(First Example of Structure of Intermittent Supply System)

A structure and a basic operation of an intermittent supply system of an inkjet printing apparatus according to the invention in its simplest form are described.

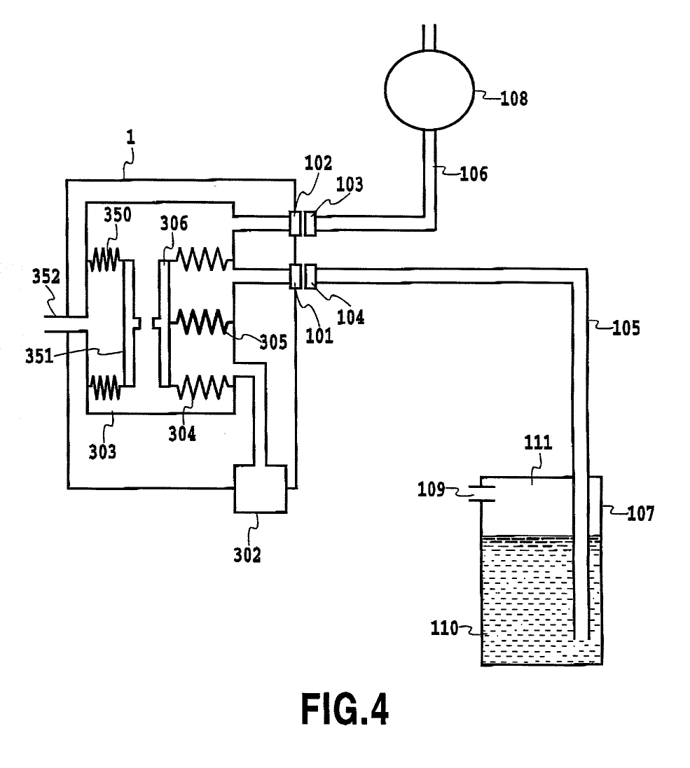

FIG. 4 is an illustration for explaining an internal structure of a printing head unit 1 used for the intermittent supply system in the structure in FIG. 1 and connection circuits coupled with and located around the same. FIG. 4 shows the printing apparatus in its attitude during use, and the upside of the figure corresponds to upside in the vertical direction.

In FIG. 4, reference numeral 302 represents a printing head on which ejection openings or nozzles are arranged in a direction different from the main scanning direction (e.g., a direction orthogonal to the same). Ejection heaters are provided in liquid paths inside the ejection openings, and each of the liquid paths are in communication with a common liquid chamber to which ink may be introduced to distribute ink in each of the liquid paths.

Reference numeral 303.represents a shell element that is a structural body for blocking communication between such an internal structure and the atmosphere in regions other than the valve units 102 and 101. Reference numeral 304 represents a second ink tank. The second ink tank 304 is constituted by a structural body which is in the form of bellows for example and which has a flexible structure that can be displaced or deformed to have a variable internal volume in accordance with the pressure in the shell element 303. The second ink tank 304 is connected to the valve unit 101 with its interior in communication with the common liquid chamber of the printing head 302. As shown in figure, in an attitude in use, the part connected to the valve unit 101 and the part in communication with the printing head 302 are in the highest and lowest positions respectively in the direction of gravity. Reference numeral 306 represents an abutting member provided at a displaced section of the structural body of the second ink tank 304.

Reference numeral 350 represents an expansion regulating member which is basically constituted by a structural body, in the form of bellows for example, which has a flexible structure that can be displaced or deformed to have a variable internal volume, like the second ink tank 304. It has an atmosphere communication port 352 for communicating the interior thereof with the atmosphere and an abutting section 351 that abuts on an abutting member 306 of the second ink tank as a result of expansion. As described later, when the valve units 102 and 103 are connected each other and then the pump unit 108 communicating those units through the tube member 106 is activated to reduce the pressure in the shell element 303, both of the second;ink tank 304 and the expansion regulating member 350 expand to cause the abutting sections 306 and 351 to abut on each other, which makes it possible to regulate the expansion beyond a predetermined amount of the second ink tank 304.

Reference numeral 305 represents a compression spring that is coupled with each of the abutting member 306 of the second ink tank 304 and the shell element 303 at an end thereof and that is set such that it exerts a force in the expanding direction or the direction of increasing the internal volume of the second ink tank 304. While the spring 305 is disposed In the second ink tank 304 in the illustrated example, it may be provided outside the same. In this case, either compression spring or tension spring may be used as long as it can exert a force in the direction of increasing the internal volume of the second ink tank 304. Instead of providing such a special spring, the material and structure of the second ink tank 304 may be appropriately selected, i.e., the bellows may be constituted by a rubber member for example to provide the second ink tank 304 with a structure Which generates a negative pressure therein by itself and which can be displaced or deformed in the direction of increasing the internal volume.

The interior of the second ink tank 304 is put in communication with the first ink tank 107 through the tube member 105 when the valve units 101 and 104 are connected. A space inside the shell element 303 and outside the second ink tank 304 is coupled with the pump unit 108 through the tube member 106 when the valve units 102 and 103 are connected The valve units 101 and 104 have a structure in which they form an ink channel when coupled with each other and close the same in an uncoupled state.

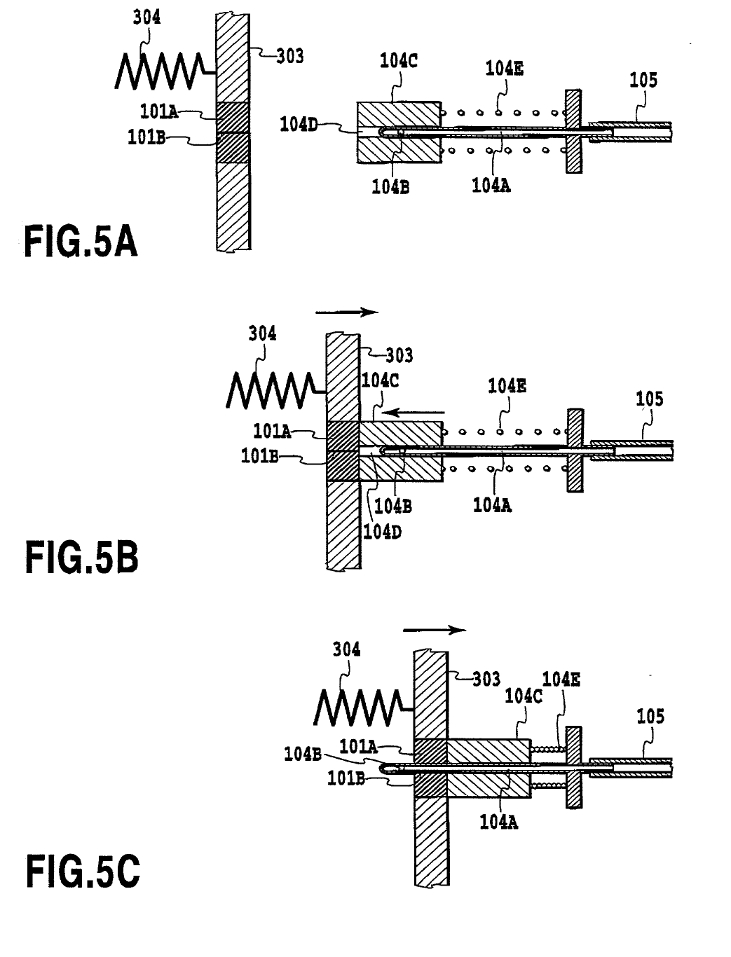

FIGS. 5A, 5B, and 5C are illustrations for explaining the structure and operation of the valve units 101 and 104:

In FIG. 5A, reference numeral 101A represents a sealing member that forms a part of the valve unit 101 and that is constituted by an elastic member such as rubber for sealing the interior of the ink tank 304, and a slit 101B is provided which is continuously extends between the inside and outside of the second ink tank 304. When the illustrated state in which the valve units 101 and 104 are not coupled, the slit 101B is closed by the elasticity of the sealing member 101A itself to keep the interior of the ink tank 304 in a gas-tight and liquid-tight state.

Reference numerals 104A through 104E represent members of which the valve unit 104 is made up. Reference numeral 104A represents a hollow needle member which Is provided at an end of the tube member 105 and which has an opening 104B on a side in the vicinity of a tip end.

Reference numeral 104C represents a closing member which covers the tip portion of the hollow needle member 104A including the opening 104B and which is constituted by an elastic member such as rubber having a through hole 104D into which the hollow needle member 104A is fitted. The closing member 104C is urged by a spring 104E provided at a flange portion of the hollow needle 104A. It is held in the illustrated position when the valve units 101 and 104 are in the uncoupled state, and the opening 104B of the hollow needle member 104A is closed by an inner wall of the through hole 104D.

When the shell 303 moves rightward in the figure for an ink charging operation from such a state in FIG. 5A, the sealing member 1l A and the closing member 104C contact each other as shown in FIG. 5B.

When the shell element 303 further moves rightward in the figure, as shown in FIG. 5C, the spring 104E is compressed, and the tip of the hollow needle member 104A proceeds in the through hole 104D in a relative manner and enters the second ink tank 304 while expanding the slit 101B by force, by which the opening 104B is located inside the second ink tank 304. This establishes communication between the first ink tank 107 and the second ink tank 304 through the tube member 105.

When the shell element 303 moves leftward in the figure after the ink charging operation is completed, the state shown in FIG. 5A is restored in which ink will not leak regardless of the attitude of the printing apparatus because the interiors of the second ink tank 304 and the first ink tank 107 are in a liquid tight state.

Obviously, the example in FIGS. 5A, 5B, and 5C is not limiting the invention, and various structures may be employed for the valve units 101 and 104 which thus form a channel in a coupled state and closes the same in an uncoupled state.

Unlike such valve units 101 and 104, the valve units 102 and 103 have no valve member to close the channel when they are disconnected. In particular, the space inside the shell member 303 and outside the second ink tank 304 is exposed to the atmosphere when they are disconnected.

Referring to FIG. 4 again, the pump unit 108 may have a pump main body in the form of a diaphragm pump, for example, and a directional control valve which is connected to an action chamber of the pump main body and which can switch a channel between the atmosphere and the valve unit 103. In the coupled state of the valve units 102 and 103, the pressure in the shell element 303 can be increased by first performing a sucking operation with the channel set in the position of the atmosphere and then performing an ejecting operation with the channel set in the position of the valve unit or shell element. Conversely, the pressure in the shell element 303 can be reduced by performing a suction operation with the channel set in the position of the valve unit or shell element and then performing an ejecting operation with the channel set in the position of the atmosphere. Obviously, the pump unit 108 may have any structure as long as it can appropriately increase or reduce the pressure in the shell element 303. Essential parts of the invention are aimed at performing the process of charging the second ink tank 304 with ink from the first ink tank 107 efficiently, and the pump unit 108 may obviously have a structure for performing only an air sucking operation from the shell element 303 if it is used for only the process of reducing the pressure inside the shell element 303 for the charging operation. Further, while depressurization is carried out by sucking air from the shell element 303 using the pump unit 108 in the present embodiment, a predetermined gas or liquid may alternatively be enclosed in the shell element 303 and a depressurizing force may be applied to the same.

While various structures are possible for the first ink tank 107 for reserving ink 110 to be supplied to the second ink tank 304 or printing head 302, the tank in the present embodiment has an atmosphere communication section 109 to always keep the pressure therein at the atmospheric pressure through communication with the atmosphere. While the atmosphere communication section 109 may be a simple hole as long as it is in a position higher than the ink level, the hole may be provided with a functional film that allows only gases to pass and disallows liquids to pass from the viewpoint of more effective prevention of leakage of ink. The tip of the tube member 105 that is stuck into the first ink tank to transport ink is located at its lowest position in the ink tank in the direction of gravity in the attitude in use as illustrated. This structure is advantageous in using up ink without any residue.

In the structure of the present embodiment, the first ink tank 107 and the second ink tank 304 have no sponge such that ink :s contained in the spaces therein as it is. This provides a structure in which ink and a gas can be quickly separated from each other downward and upward respectively in the direction of gravity without any obstacle.

(Example of Ink Charging Process)

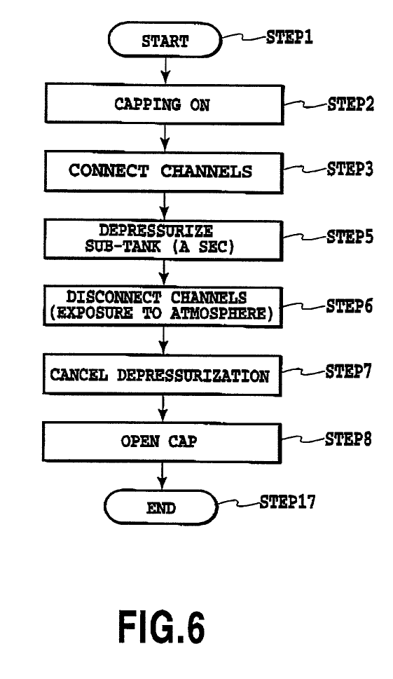

FIG. 6 shows an example of a processing procedure for charging ink from the first ink tank 107 to the second ink tank 304 in the above structure.

For example, when image data are supplied and printing is instructed by the host apparatus 210 to activate the procedure (Step 1), a capping operation is first performed at Step 2. This is an operation of moving the cap section of the recovery system mechanism indicated by reference numeral 100 in FIG. 1 to put it in tight contact with the surface of the printing head 302 in FIG. 4 where the ejection openings are formed, thereby forming a closed system in that part.

An operation of connecting the valve units 101 through 104 is then performed at Step 3. That is, the carriage 2 is moved in the main scanning direction in the structure in FIG. 1 to cause the valve units 101 and 102 to abut on the valve units 104 and 103 respectively, thereby forming an ink channel and an air channel. The invention is not limited to this method of connection. The channels in the valve units 101 and 104 are closed until they are connected, and both of the channels are opened and coupled with each other at the time of connection. The valve units 102 and 103 are always open, and an air channel is formed as they are coupled.

The procedure then proceeds to Step 5 at which the pump unit 108 is operated for depressurization. Since the pressure In the shell element 303 becomes lower than the atmospheric pressure as a result of the depressurizing operation of the pump unit 108, the second ink tank 304 expands to cause ink to flow from the first ink tank 107 into the second ink tank 304 through the tube member 105 and the valve units 104 and 101. At the same time, the expansion regulating member 350 also expands because outside air flows into the expansion regulating member 350 through the atmosphere communication port 352. When the depressurizing operation is continued for a predetermined time (A seconds), the abutting member 306 of the second ink tank 304 and the abutting section 351 of the expansion regulating member 350 finally abut on each other, and any further expansion of the second ink tank 304 is prevented by the abutment of them.

Next, the carriage 2 is moved toward the printing area in the main scanning direction at Step 6 to decouple the valve units. At this time, both of the valve units 101 and 104 operate to close the channel, and the valve unit 102 is left in the open state. The depressurizing operation therefore substantially terminates then. Subsequently, the driving of the pump unit 108 is stopped at Step 7 to cancel the depressurizing operation, and the capped state provided by the recovery system mechanism 100 is canceled at Step 8 to terminate the process (Step 17).

In a structure in which a fixed stopper is provided in the shell element 303 instead of the expansion regulating member 350 and in which the ink charging operation is completed with the abutting member 306 of the second ink tank 304 abutting on the fixed stopper, the compression spring 305 cannot freely extend, i.e., it cannot apply an adequate negative pressure to the printing head 302 as it is. In such a structure, an additional operation is performed in which pressurization is performed for a short time after depressurization for charging to push a small amount of ink in the second ink tank 304 back to the first ink tank 107 and in which the second ink tank 304 is thus contracted to space the abutting member 306 from the stopper 307, thereby allowing an adequate negative pressure to be generated by the compression spring 305.

In this example, however, the structures of the second ink tank 304 and the expansion regulating member 350 are appropriately defined such that the valve units are disconnected after that the operation of charging the second ink tank 304 with ink is completed as a result of the abutment between the second ink tank 304 and the expansion regulating member 350, to expose the interior of the shell element 303 to the atmosphere (Step 6); the expansion regulating member 350 in communication with the atmosphere is thus allowed to contract while allowing the compression spring 305 to expand when the depressurizing operation is stopped (Step 7); and the second ink tank 304 is thus allowed to generate an adequate negative pressure. That is, the compression spring 305 is allowed to be displaced in the direction of increasing the internal volume of the second ink tank 304 after the charging operation is completed such that the expansion of the second ink tank 304 stops when it is balanced against a meniscus holding ability of the printing head. This makes it possible to reduce the time required for enabling printing.

The spring constant of the compression spring 305 is desirably set such that the negative pressure is maintained in a range of optimum values at which ink can be ejected from the printing head properly from this state until the internal volume of the second ink tank 304 is minimized as a result of the consumption of ink.

In the event that air enters in the second ink tank 304, the air is tempted to expand in response to a temperature rise. When the ink charging operation has then proceeded to disallow any further expansion of the second ink tank 304, a problem can arise in that the internal pressure of the second ink tank increases to cause ink to leak through the ejection openings. It is therefore desirable to limit the ink charging operation to a such range that the second ink tank itself can still expand in order to allow the expansion of air, the expansion regulating member 350 is used to ensure that the expansion of the second ink tank 304 is stopped at a predetermined position for this reason too.

The above structure and process make it possible to supply ink to the second ink tank intermittently in a simple manner without generating any waste ink as a result of a charging operation.

A structure is employed with which the internal volume of the second ink tank 304 can be varied to generate an adequate negative pressure, and the second ink tank 304 itself functions as an actuator for charging ink by varying the internal volume thereof, by which those operations can be achieved by driving and controlling a single source of driving.

Although a capping operation is performed at the beginning of the ink charging process in the above procedure, the capping operation may be omitted when fluctuations of the pressure in the second ink tank 304 determined by the rate of expansion of the second ink tank 304 and the relationship between ink channel resistances of the first ink tank 107 and the second ink tank 304 are smaller than the meniscus holding pressure of the ejection openings. Such an alternative may be taken when the rate of expansion is low because of a low ink flow rate and when the resistances of the channels are small because of great channel sectional areas, for example.

(Specifications of Intermittent Supply System) A description will now be made on conditions such as dimensions and specifications of each part of the intermittent supply system to be satisfied to ensure the stoppage.

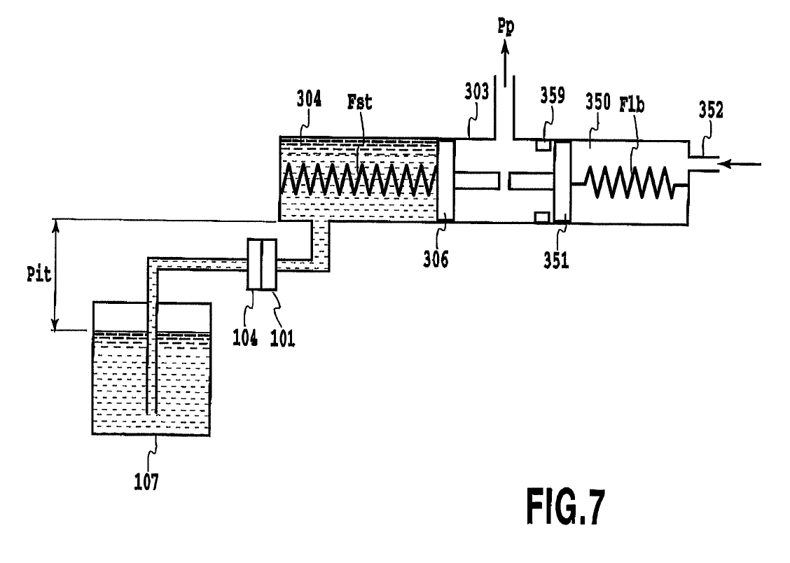

FIG. 7 shows a model of the structure in FIG. 4. A left part of a shell element 303 shown as having a cylindrical shape corresponding to the second ink tank 304, a right part of the same corresponding to the expansion regulating member 350. A space located between those parts is in communication with the pump unit 108, and a pressure Pp is applied to the same as a result of a depressurizing operation. Fst represents a composite spring force provided by the second ink tank 304 itself and the compression spring 305, the force defining negative pressure to be applied to the printing head. Flb represents a spring force of the expansion regulating member 350 itself, the force acting in the direction of contracting the expansion regulating member. A pressure that is applied to the second ink tank 304 in accordance with the relationship between the heights of the first ink tank 107 and the secondink tank 304 (the difference between the head heights)is represented by Pit.

Pressure bearing areas of the abutting member 306 of the second ink tank 304 and the abutting section 351 of the expansion regulating member 350 are represented by Ast and Alb, respectively. When the second ink tank 304 is expanded by the depressurizing operation of the pump unit 108, the abutting member 306 of the second ink tank 304 is moved rightward in the figure by a force applied thereto that is expressed by:

(Pp×Ast)+Fst+(Pit×Ast)

The abutting section 351 of the expansion regulating member 350 is moved leftward in the figure by a force applied thereto that is expressed by:

(Pp×Alb)−Flb

In order for the abutting sections to abut on each other and to stop in such a state, the following condition must be satisfied.

(Pp×Ast)+Fst+(Pit×Ast)=(Pp×Alb)−Flb Equation 1

The expansion of the second ink tank 304 is regulated in an adequate position to complete ink charging if conditions such as the dimensions and specifications of each part are determined such that the above condition is satisfied.

However, in order to regulate the expansion of the second ink tank 304 with reliability, the following relationship is preferably satisfied:

(Pp×Ast)+Fst+(Pit×Ast)<(Pp×Alb)−Flb Equation 2

That is, the force exerted by the abutting section 351 of the expansion regulating member 350 is preferably greater than the force exerted by the abutting member 306 of the second ink tank 304. It is also preferable to provide a stopper 359 for limiting the movement of the abutting section 351 of the expansion regulating member 350 at a predetermined position in order to prevent the second ink tank 304 from contracting in an undesirable amount after the abutment.

When the ink channel to the first ink tank 107 is blocked to cancel depressurization after stability is achieved in the stopped state, since only the composite spring force Fst originating from the second ink tank 304 itself and the compression spring 305 acts, the pressure in the second ink tank 304 (the negative pressure relative to the printing head) Pst is expressed as follows:

Pst=−Fst/Ast Equation 3

It is therefore desirable that the composite spring force of the second ink tank 304 itself and the compression spring 305, in particular, the spring constant of the compression spring 305 is set such that Ink meniscuses at the ejection openings are held regardless of the attitude or orientation of the printing apparatus and such that a negative pressure in a range of optimum values at which ink can be properly ejected from the printing head is maintained from the ink charged state until the internal volume of the second ink tank 304 is minimized as a result of the consumption of ink. That is, it is desirable that a relationship expressed by Pst= Nt is satisfied where Nt represents the ink meniscus holding ability.

The values in Equation 2 may be determined based on the relationship among the factors. For example, the areas of the inner surfaces of the abutting sections 306 and 351 may be determined according to the negative pressure to be applied to the printing head, the head difference between the second ink tank 304 and the first ink tank 107, the pressure for depressurization, and the spring force.

This will be described with specific numerical values Providing

Providing to neglect the spring force Flb of the expansion regulating member 350 itself in the direction of contacting the same that is assumed to be very small and providing to substitute the relationship expressed by Equation 3 in Equation 2, Equation 2 is changed as follows:

Pp×Alb>(Pp−Pst+Pit)×Ast Equation 4

It is assumed that the first ink tank 107 is located lower than the second ink tank 304 in the direction of gravity to apply a pressure Pit=−0.7 KPa, for example, to the second ink tank 304 in the example of structure in FIG. 4 and the model in FIG. 7. It is assumed further that a pressure Pp=30 KPa is applied to the interior of the shell element 303 through the depressurizing operation performed by the pump unit 108. It is further assumed that a negative pressure Pst=−1 KPa is exerted by the second ink tank 304. Then, those values are substituted in Equation 4, the calculation of which indicates that the area Alb of the inner surface of the abutting section 351 of the expansion regulating member 350 may be greater than about 1.01 times the area Ast of the inner surface of the abutting member 306 of the second ink tank 304.

That is, when the difference Pp×(Alb-Ast) between the forces exerted by the expansion regulating member 350 and the second ink tank 304 is relatively large, the influence of a force originating from the head difference of the first ink tank 107 can be substantially cancelled.

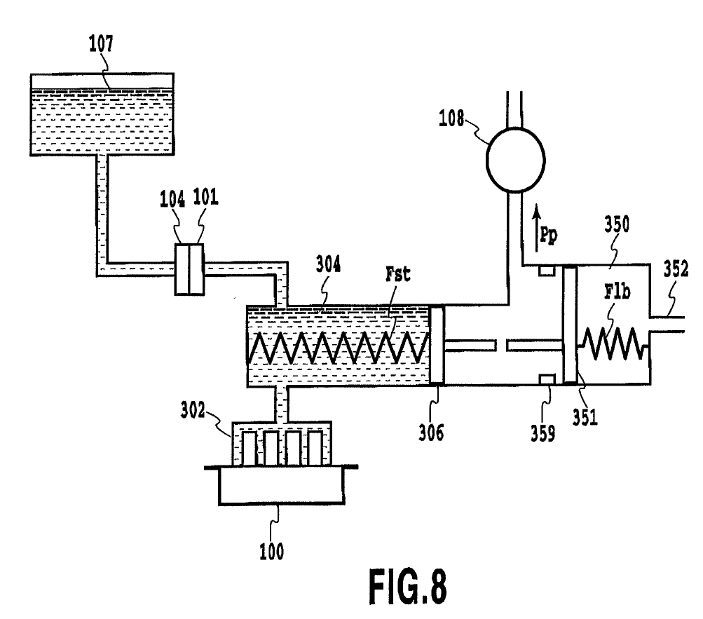

A case will now be discussed in which the first ink tank 107 is located higher than the second ink tank 304 in the direction of gravity as shown in FIG. 8. In this case, it is assumed that a pressure Pit=+0.5 KPa is applied to the second ink tank 304, for example. Let us assume further that a pressure Pp=30 KPa is applied to the interior of the shell element 303 through the depressurizing operation performed by the pump unit 108. Let us further assume that a negative pressure Pst=−1 KPa is exerted by the second ink tank 304. Then, those values are substituted in Equation 4, the calculation of which indicates that the area Alb of the inner surface of the abutting section 351 of the expansion regulating member 350 may be greater than about 1.05 times the area Ast of the inner surface of the abutting member 306 of the second ink tank 304 and that the capability of canceling the influence of the pressure in the first ink tank is improved by increasing the difference between the areas.

By determining the dimensions of the second ink tank 304 and the expansion regulating member 350 as described above, the expansion of the second ink tank 304 can be reliably stopped by the expansion regulating member 350 in an appropriate position regardless of the pressure Pit applied to the second ink tank 304 according to the head difference between the second ink tank 304 and the first ink tank 107.

(Examples of Structures of Second Ink Tank and Air Pressure Type Expansion Regulating Member)

In order to stop the second ink tank 304 with reliability as described above, the structures of the second ink tank 304 expanding as a result of a reduction of the pressure in the shell element 303 and the expansion regulating member 350 is appropriately determined.

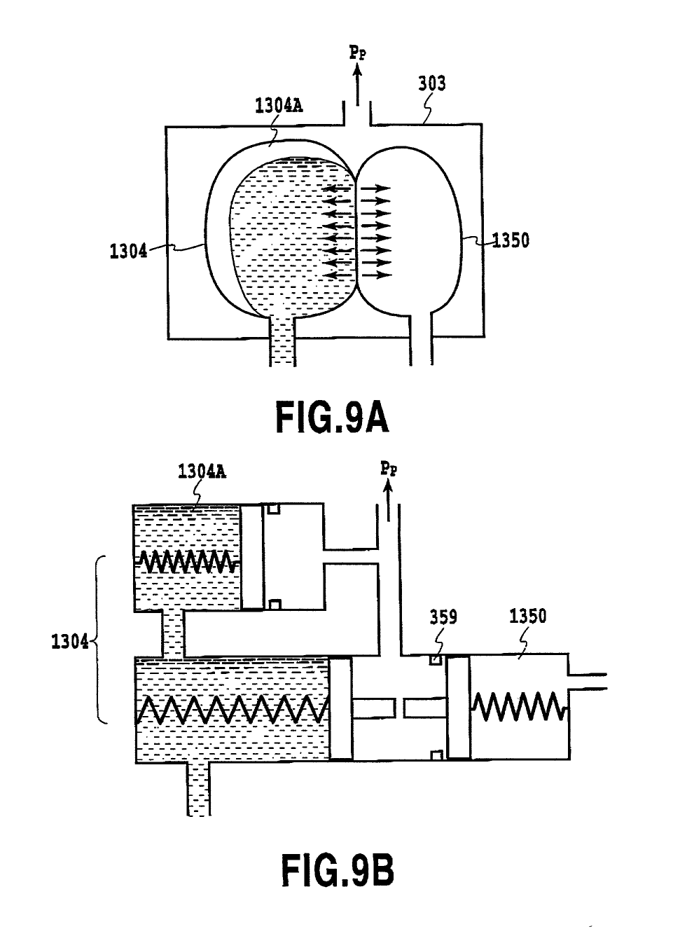

For example, when a second ink tank 1304 and an expansion regulating member 1350 each having a bag-like structure that is simply in the form of a balloon are adopted as shown in FIG. 9A, they have equal contact areas when they abut on each other, and it is difficult to regulate the expansion of the second ink tank 1304 in an appropriate position with stability. Further, the influence of a relative head difference between them cannot be eliminated depending on the position of the first ink tank 107, which makes the regulation of expansion more difficult.

Further, since parts of the second ink tank 1304 that are not in contact with the expansion regulating member 1350 also expand in the gap between the shell element 303, as shown in a model in FIG. 9B, the pressure in the second ink tank 1304 after the cancellation of a depressurizing operation includes the pressure in such expanding parts 1304A added thereto, which disallows the generation of a negative pressure that is adequate for the printing head 302 and may rather result in a positive pressure. A problem arises in that the positions and structures of the stopper 359 and the member to regulate the expansion of the second ink tank 1304 as a whole must be precisely determined in order to prevent this.

In this regard, it is adequate to provide the second ink tank 304 and the expansion regulating member 350 with a structure in the form of bellows whose expanding direction is linearly regulated and to form the displaced sections as abutting sections in the form of flat plates, as shown in FIGS. 4 and 7 or FIG. 8. It is also preferable to form rods in the section such that parts acting as centers of application of pressures abut on each other as shown in those figures.

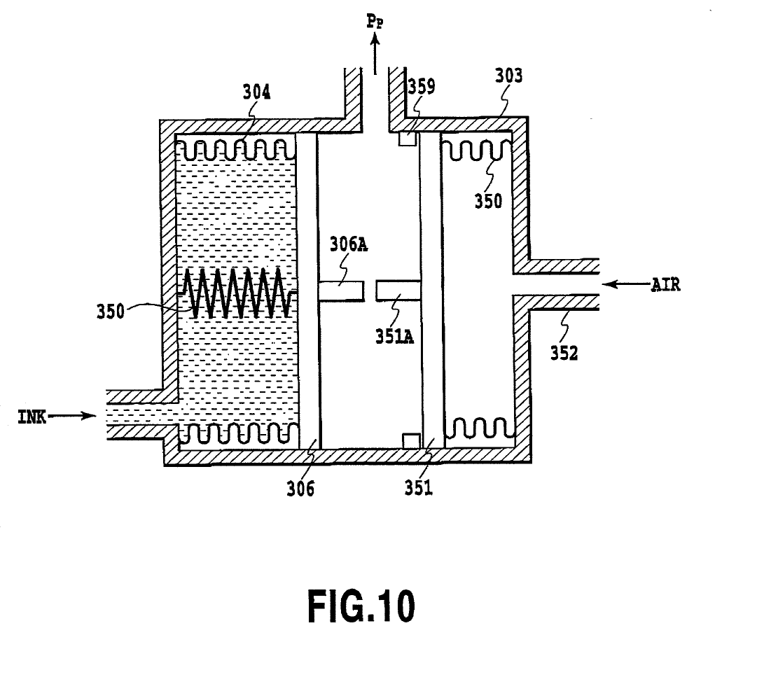

FIG. 10 schematically shows such a structure. Specifically, it shows a structure in which a second ink tank 304 and an expansion regulating member 350 in the form of bellows having appropriately defined specifications such as dimensions and positions are provided in a shell element 303 and in which rods 306A and 351A are provided in parts of abutting sections 306 and 350 in the form of flat plates that abut on each other.

In order to prevent the second ink tank 304 from contracting in an undesirable amount after the abutment, a stopper 359 is provided to limit the movement of the abutting section 351 of the expansion regulating member 350 to a predetermined position and to consequently limit the expansion of the second ink tank 304 to a predetermined position. The predetermined positions are positions for limiting a charging operation to a range in which the second ink tank 304 can expand to generate a negative pressure appropriate for the printing head 302 and to allow expansion as a result of an increase in the temperature of the air that has entered the tank.

Other structures may be adopted as long as the expansion of the second ink tank is appropriately regulated.

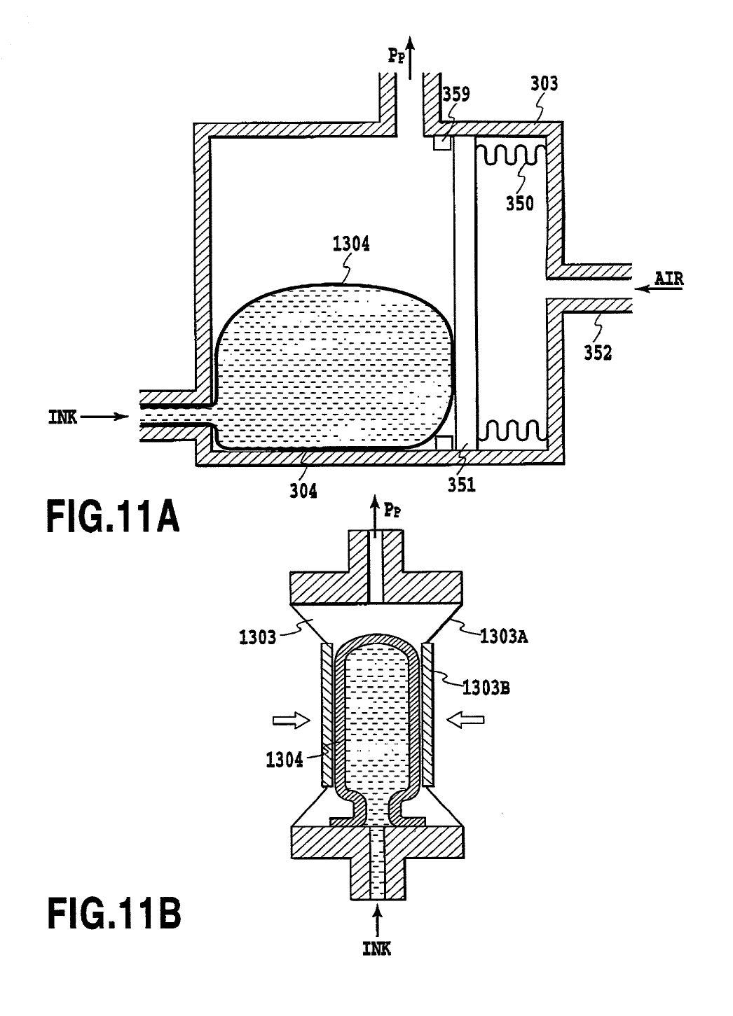

FIGS. 11A and 11B show two examples of such structures.

In FIG. 11A, a bag-like second ink tank 1304 is provided, and the area of the abutting section 351 of the expansion regulating member 350 is made relatively large to maintain a wide area of the same out of contact with the bag-like second ink tank 1304, by which a relatively large force is exerted by the expansion regulating member 350. In this case, the area of the abutting section 351 preferably has some margin in consideration to the fact that the second ink tank 1304 expands in the gap in the shell element 303 and the fact that a depressurizing operation is performed when the second ink tank 1304 is completely charged. 20 Referring to FIG. 11B, a shell element 303 having a so-called flexible structure is adopted in which a bag-like second ink tank 1304 is similarly provided; a flexible sheet 1303A that can be deformed In the direction of sandwiching the second ink tank through a reduction of its internal volume as a result of depressurization is provided; and plate-like members 1303B are provided in parts that perform such sandwiching.

While an intermittent supply system is configured for one type of ink in the above examples, a similar intermittent supply system can be configured to accommodate inks of two or more colors or type.

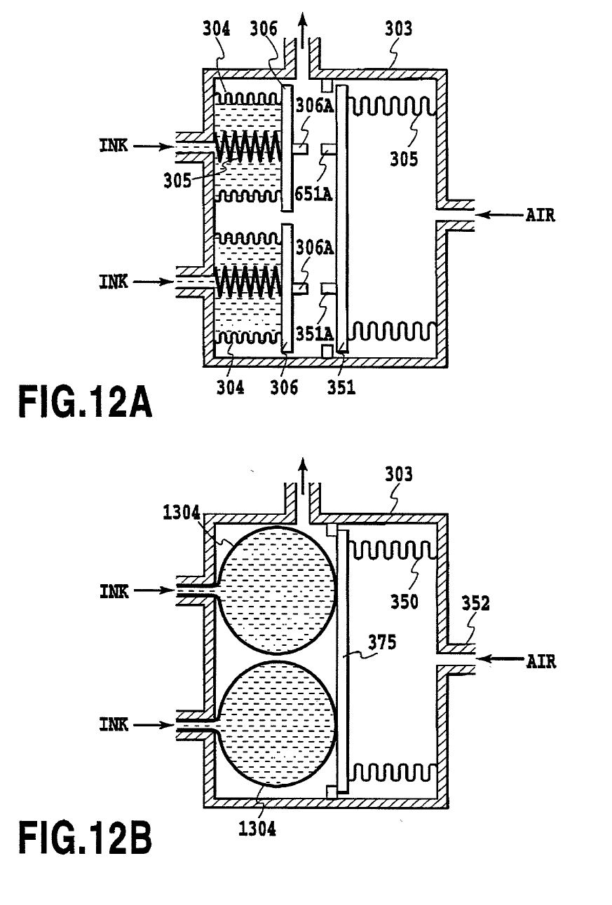

FIGS. 12A and 12B are illustrations of two examples of such structures.

FIG. 12A shows a structure in which two second Ink tanks 304 in the form of bellows are provided in a shell element 303 in association with two types of inks and in which an expansion regulating member 350 in the form of bellows for commonly regulating the expansion of the tanks is provided FIG. 12B shows a structure in which two bag-like second ink tanks 1304 are similarly provided in a shell element 303 and in which an expansion regulating member 350 in the form of bellows for commonly regulating the expansion of them is provided.

While FIGS. 12A and 12B show examples of structures to allow the use of two types of inks for simplicity, it is obvious that an intermittent supply system can be configured to allow the use of more types of inks, e.g., four or six types of inks based on the same idea.

Those examples have the following advantages in addition to the fact that a plurality of systems (two systems in the illustrated example) is provided. A mechanism (pump unit 108) for pressurization and depressurization and a shell element can be basically used commonly, which is suitable for a design of a more compact printing apparatus. Common peripheral mechanisms can be used even when it is required to use second ink tanks having different sizes that depend on colors and types of inks used in a printing apparatus. Second ink tanks having remaining inks in different amounts can be charged at a high speed by adjusting the amounts of all types of inks to respective optimum values using a control sequence for a single pump unit without performing individualized control.

An increase in ink types can be accommodated in the internal structure of the printing head by simply disposing the second ink tanks in a quantity corresponding to the ink types, and peripheral mechanisms (such as the shell element, pump unit, and expansion regulating member) can be used commonly, which provides a very much advantageous technique in designing a portable, thin, or compact printer.

Further, even when the second ink tanks have remaining inks in different amounts between the ink types, the expansion of each second ink tank occurring in response to depressurization can be prevented when the ink tank abuts on the expansion regulating member 350 to allow the respective ink to be charged in a prescribed amount. A control sequence equivalent to the processing procedure shown in FIG. 6 can be used, which fundamentally eliminates the need for performing minute control in accordance with the difference between the amounts of the different types of remaining inks. When a design is employed in which the maximum ink capacity is different for each type of ink, inks can be automatically charged to the respective maximum capacities. This is very much advantageous for a design in which different capacities are provided for a black ink and a color ink, for instance.

(Other Embodiments)

The above embodiments have referred to examples of structures of a so-called air pressure type expansion regulating member that is deformed or displaced in accordance with the a reduction of the pressure in a shell element to regulate the expansion of the second ink tank. However, the invention is not limited to the above examples, and various structures may obviously be adopted as long as they make it possible to obtain an adequate negative pressure only by effectively regulating the expansion of the second ink tank and by completing the charging operation through depressurization, and to thereby reduce the time required for enabling printing.

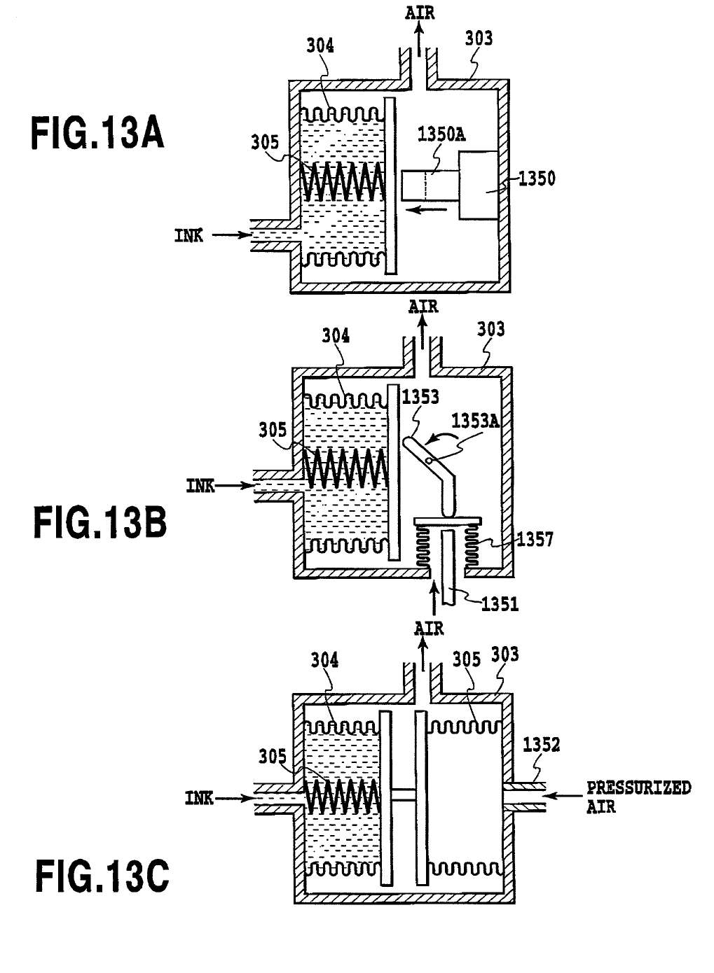

FIGS. 13A, 13B, and 13C show three examples of such structures.

Referring to FIG. 13A, instead of the air pressure type expansion regulating member 350, there is provided a mechanical expansion regulating member having an actuator that can be displaced to a position at which the expansion of the second ink tank 304 can be appropriately regulated e.g., a solenoid type expansion regulating member 1350 having a rod 1350A that protrudes in response to energization. The expansion regulating member 1350 is driven to cause the rod 1350A to protrude during the depressurizing operation for charging ink, and the driving is canceled when the depressurizing operation is completed to retract the rod 1350A.

Referring to FIG. 13B, there is provided an arm member 1353, one end of which is engaged with an actuator that can be displaced from the outside of the shell element 303 toward the inside of the same, e.g., a solenoid rod 1351 protruding in response to energization and being accommodated in bellows 1357, another end of which can abut on the abutting member 306 of the second ink tank 304, and which can be rotated about a pivot 1353A in response to protrusion and retraction of the solenoid member 1351. The expansion regulating member 1350 is driven to cause the rod 1351 to protrude during the depressurizing operation for charging ink, thereby rotating the arm 1353 toward a regulating position, and the driving is cancelled after the depressurizing operation to cause the rod 1350A to retract, thereby rotating the arm 1353 out of the regulating position.

FIG. 13C shows a structure which is basically the same as that in FIG. 10 except that pressurized air can be introduced into an air pressure type expansion regulating member 350 through a port 1352 instead of keeping the interior of the same always in communication with the atmosphere. The pressurized air is introduced during the depressurizing operation for charging ink, and the interior of the member is exposed to the atmosphere after the depressurizing operation is completed to allow this member to contract.

Although, a printing head is not shown in some figures illustrating examples, the same structure as shown in FIG. can be applied to those examples relating to the printing head.

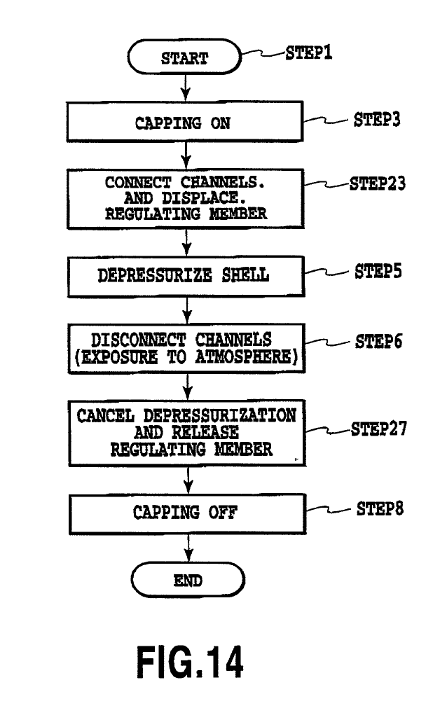

FIG. 14 shows an example of a procedure for an ink charging process performed using any one of the structures shown in FIGS. 13A, 13B, and 13C. Basically, a sequence similar to that in FIG. 6 is executed.

The present procedure is different from the procedure in FIG. 6 in that Step 3 in FIG. 6 is replaced with Step 23 for connecting the channels and for driving the regulating member for displacement and in that Step 7 in FIG. 6 is replaced with Step 27 for canceling depressurization and canceling driving to retract the regulating member.

Even when those structures are adopted, the regulating position is set at a position where the charging operation is limited to a range in which the second ink tank 304 can expand in order to allow a negative pressure appropriate for the printing head 302 to be generated and to allow expansion as a result of an increase in the temperature of air that has entered.

(Others)

Each of the embodiments described above corresponds to the printing apparatus in FIGS. 1 having a structure in which the valve units are coupled only when the second ink tank is charged with ink and in which the ink supply system between the first and second ink tanks is spatially disconnected during a printing operation However, those basic structures may be applied to the printing apparatus in FIG. 2 that employs an intermittent supply system configured to achieve fluid isolation between the first and second ink tanks without performing Such disconnection.

That is, one end of a flexible tube member 150 for an air pressure circuit and one end of a flexible tube member 151 for supplying ink may be connected to the printing head 1 or the shell member 303 shown in FIG. 4, and channel opening and closing units such as electromagnetic valve units 152 may be interposed between the tube members 150, 151 and the tube members 106, 105 instead of the valve units 101 through 104. An operation similar to that of the above embodiments can be performed by actuating the electromagnetic valve units 152 during a charging operation to connect the second ink tank 304 and the first ink tank 107 and to connect the interior of the shell element 303 and the pump unit 108.

As described above, the invention makes it possible to provide a structure in which an intermittent supply system is adopted as an ink supply system; a second ink tank is charged with ink with high efficiency in a short charging time; and ink is used with high efficiency as a whole. The invention thus contributes to the structure of a compact and portable inkjet printing apparatus.

The present invention has been described in detail with respect to preferred embodiments, and it will now be apparent from the foregoing to those skilled in the art that changes and modifications may be made without departing from the invention in its broader aspects, and is it is the intention, therefore, in the appended claims to cover all such changes and modifications as fall within the true spirit of the invention.

What is claimed is:

1. An ink container that can be disposed halfway of an ink supply path connecting a printing head for performing printing by ejecting ink and an ink tank serving as a supply source of ink to be supplied to said printing head, comprising:
an ink containing body capable of containing ink introduced thereto from said ink tank in a state in which it is in fluid communication with said ink tank, said ink containing body supplying the ink contained therein to said printing head during printing and having a part that can be displaced in the direction of increasing an internal volume thereof to introduce the ink;
a housing having an inner space in which a pressure can be adjusted, said housing allowing said ink containing body to be contained in the space and allowing an increase in the internal volume thereof in accordance with the pressure adjustment; and
regulating means provided in said housing such that it can regulate the displacement of the part of said ink containing body in the direction of increasing the internal volume to a predetermined position.

2. An ink container as claimed in claim 1, wherein said ink containing body is provided with urging means for urging said ink containing body in the direction of increasing the internal volume thereof to generate a negative pressure in equilibrium with an ability to hold meniscuses formed at an ink ejecting portions of said printing head.

3. An ink container as claimed in claim 2, wherein the regulation performed by said regulating means is canceled to allow urging of said urging means, thereby putting said ink containing body under the negative pressure in equilibrium with the ability to hold meniscuses.

4. An ink container as claimed in claim 1, wherein the regulation performed by said regulating means is canceled to allow said ink containing body to expand, thereby allowing air present in said ink containing body to expand.

5. An ink container as claimed in claim 1, wherein said ink containing body has a flexible structure which expands when the inner space of said housing is depressurized to increase said internal volume.

6. An ink container as claimed in claim 5, wherein said ink containing body has a member having an end attached to an inner wall of said housing and another end that can be displaced according to the expansion; said member can be put in fluid communication with said ink tank through a channel extending through said wall of said housing and the end; and an abutting section whose displacement is regulated by said regulating means is provided at the other end of said member.

7. An ink container as claimed in claim 6, wherein said urging means has a spring for urging the other end of said member in the direction of expanding of said member.

8. An ink container as claimed in claim 1, wherein the pressure in the inner space of said housing is adjusted using a gas or a liquid as a medium.

9. An ink container as claimed in claim 1, having a configuration in which it is directly connected to said printing head.

10. An ink container as claimed in claim 1, wherein said housing contains said ink containing body In a quantity corresponding to the types of inks to be used and wherein said regulating means is commonly used by said in containing bodies.

11. An ink container as claimed in claim 1, wherein said regulating means has a regulating member which can expand according to depressurization of the inner space of said housing and which abuts on the part of said ink containing body as a result of the expansion to regulate the displacement of the same.

12. An ink container as claimed in claim 11, wherein said regulating member has a member having an end attached to an inner wall of said housing and another end that can be displaced according to the expansion; said member is in communication with the atmosphere through an atmosphere communication section extending through said wall of said housing and the end; and an abutting section that abuts on the part is provided at the other end.

13. An ink container as claimed in claim 1, wherein said regulating means has a regulating member that can be displaced to a position in which it abuts on the part of said ink containing body to regulate the displacement of the same.

14. An ink container as claimed in claim 13, wherein said regulating member has a rod which can protrude towards the regulating position in accordance with an external signal.

15. An ink container as claimed in claim 13, wherein said regulating member has a member which can expand in response to introduction of pressurized air and which is displaced toward the regulating position as a result of the expansion.

16. An ink container as claimed in claim 13, wherein said regulating member has a member which can be rotated towards the regulating position in response to the application of an external force.

17. An inkjet printing apparatus for performing printing by using a printing head for ejecting ink, an ink tank serving as a source of ink to be supplied to said printing head, and an ink container provided halfway of an ink supply path connecting said printing head and said ink tank as claimed in claim 11 said apparatus comprising:
channel opening and closing means for establishing and blocking fluid communication between said ink tank and said ink containing body; and
pressure adjusting means for reducing the pressure in the inner space of said housing in the communicated state to increase the internal volume of said ink containing body and to expand said regulating member and for canceling the depressurized state after the regulation is performed.

18. An inkjet printing apparatus as claimed in claim 17, wherein said channel opening and closing means blocks said channel when said pressure adjusting means cancels the depressurization.

19. An inkjet printing apparatus as claimed in claim 17, wherein said printing head and said ink container are integrally formed.

20. A printing apparatus as claimed in claim 17, wherein said printing head has a heating element for generating thermal energy that causes film boiling of ink as energy used to eject the ink.

21. An inkjet printing apparatus for performing printing by using a printing head for ejecting ink, an ink tank serving as a source of ink to be supplied to said printing head, and an ink container provided halfway of an ink supply path connecting said printing head and said ink tank as claimed in claim 13, said apparatus comprising:
channel opening and closing means for establishing and blocking fluid communication between said ink tank and said ink containing body;
pressure adjusting means for reducing the pressure in the inner space of said housing in the communicated state to increase the internal volume of said ink containing body; and
control means for displacing said regulating member towards the regulating position and for displacing said regulating member from the regulating position after the regulation is performed.

22. An inkjet printing apparatus as claimed in claim 21, wherein said control means displaces said regulating member towards the regulating position when the fluid communication is established by said channel opening and closing means, and displaces said regulating member from the regulating position when the reducing operation of the pressure is canceled by said pressure adjusting means, and wherein said channel opening and closing means blocks said channel when the reducing operation of the pressure is canceled by said pressure adjusting means.

23. An inkjet printing apparatus as claimed in claim 21, wherein said printing head and said ink container are integrally formed.

24. A printing apparatus as claimed in claim 21, wherein said printing head has a heating element for generating thermal energy that causes film boiling of ink as energy used to eject the ink.

25. An ink supplying method used for an inkjet printing apparatus for performing printing by using a printing head for ejecting ink, an ink tank serving as a source of ink to be supplied to said printing head, and an ink container provided halfway of an ink supply path connecting said printing head and said ink tank as claimed in claim 11, said method for supplying the ink to said ink container from said ink tank, said method comprising the steps of:
establishing fluid communication between said ink tank and said ink containing body;
reducing the pressure in the inner space of said housing in the communicated state to increase the internal volume of said ink containing body and to expand said regulating member; and
canceling the depressurized state after the regulation is performed.

26. An ink supplying method as claimed in claim 25, further comprising the step of blocking said channel when said pressure adjusting means cancels the depressurization.

27. An ink supplying method used for an inkjet printing apparatus for performing printing by using a printing head for ejecting ink, an ink tank serving as a source of ink to be supplied to said printing head, and an ink container provided halfway of an ink supply path connecting said printing head and said ink tank as claimed in claim 13, said method for supplying the ink to said ink container from said ink tank, said method comprising the steps of:
establishing fluid communication between said ink tank and said ink containing body;
reducing the pressure in the inner space of said housing in the communicated state to increase the internal volume of said ink containing body; and
controlling to displace said regulating member towards the regulating position and to displace said regulating member from the regulating position after the regulation is performed.

28. An ink supplying method as claimed in claim 27, wherein said controlling step has a step of displacing said regulating member towards the regulating position when the fluid communication is established and a step of displacing said regulating member from the regulating position when the reducing operation of the pressure is canceled, and said method further comprising a step of blocking said channel when the reducing operation of the pressure is canceled.

29. An ink supplying method for supplying ink to an ink container accommodating an ink containing body capable of containing the ink therein and capable of generating a negative pressure by an elastic force from an ink tank serving the ink to be supplied to a printing head, said method comprising the steps of:
establishing fluid communication between said ink tank and said ink containing body;
depressurizing the interior of said ink container to expand said ink containing body, thereby introducing the ink to said ink containing body from said ink tank; and
regulating the expansion of said ink containing body by using displaceable regulating means, thereby stopping the introduction of the ink.

30. An ink supplying method for supplying ink to an ink container accommodating an ink containing body capable of containing the ink therein and capable of changing an internal volume thereof with a flexible structure from an ink tank serving the ink to be supplied to a printing head, said method comprising the steps of:
establishing fluid communication between said ink tank and said ink containing body;
increasing the internal volume of said ink containing body, thereby introducing the ink to said ink containing body from said ink tank; and
regulating the increase of the internal volume of said ink containing body by using displaceable regulating means, thereby stopping the introduction of the ink.

31. An ink supplying method as claimed in claim 30, further comprising a step of canceling the regulation by said regulating means to put said ink containing body under a negative pressure in equilibrium with an ability to hold meniscuses formed at an ink ejecting portions of said printing head.
